(19) United States
(12) Patent Application Publication
(10) Pub. No.: US 2025/0377225 A1
(43) Pub. Date: Dec. 11, 2025

(54) SENSOR MODULE HAVING ENVIRONMENTAL SENSOR AND CLIMATE CONTROL DEVICE

(71) Applicant: Webasto SE, Stockdorf (DE)

(72) Inventors: Fabian WILL, Stockdorf (DE); Juraj LEHOTSKY, Stockdorf (DE)

(21) Appl. No.: 19/229,528

(22) Filed: Jun. 5, 2025

(30) Foreign Application Priority Data
Jun. 10, 2024 (DE) 10 2024 116 075.6

(51) Int. Cl. G01D 11/24

(52) U.S. Cl. CPC G01D 11/245

(57) ABSTRACT

A sensor module for a motor vehicle may have a see-through area, an environmental sensor, which can detect the vehicle surroundings through the see-through area, and a climate control device (28) for the climate control of the environmental sensor, wherein the climate control device has a cooling device having a contact element for in particular thermally contacting and cooling the environmental sensor and a heating device having at least one heating element, wherein the at least one heating element is arranged at the contact element or is integrated in the contact element.

### CROSS-REFERENCE TO RELATED APPLICATION

This application claims the benefit of DE Application No. 10 2024 116 075.6, filed Jun. 10, 2024, which is incorporated herein by reference in its entirety.

### TECHNICAL FIELD

The invention relates to a sensor module, in particular a roof sensor module (RSM), for a passenger vehicle, which comprises an environmental sensor for detecting the vehicle environment. Furthermore, the invention relates to a vehicle roof having such a sensor module. The invention also relates to a motor vehicle having such a sensor module and/or such a vehicle roof.

### BACKGROUND

Vehicle roofs are known from practice. A vehicle roof can be designed, for example, as a roof sensor module, which can be placed as a separate modular unit on a vehicle body of a passenger vehicle forming a vehicle shell. As an interface to the vehicle roof, the vehicle body comprises roof spars, which can be designed as longitudinal spars and/or as transverse spars and represent a carrier device on the vehicle shell side. The vehicle roof comprises a roof skin, which forms an outer visible surface and comprises sensor see-through areas, through which environmental sensors, which are used to detect the vehicle surroundings and are arranged under the roof skin, can detect the vehicle surroundings.

Vehicles driving in an autonomous or semiautonomous manner comprise, for example, a roof designed as a roof sensor module (RSM), which is equipped with a plurality of environmental sensors. The environmental sensors, which are integrated into a dry area in the vehicle roof designed in particular as a roof sensor module and which are designed, for example, as lidar sensors and/or as radar sensors and/or as cameras, detect the surroundings all around the vehicle and provide corresponding measurement signals to a control electronics unit of the relevant vehicle, so that a respective traffic situation can be determined and the driving behaviour of the relevant vehicle can be adapted to this traffic situation.

A critical aspect of RSM technology is the temperature regulation of the environmental sensors, such as lidar sensors, which are integrated into the RSM modules. To ensure optimum functionality and a long lifetime of the environmental sensors, it is essential that these operate within their specified working temperature ranges. This results in the necessity of using separate thermal management modules for heating and cooling.

The cooling module has the task of cooling down the sensor or a combination of various environmental sensors within the RSM from a high temperature level, which is significantly above the maximum permissible working temperature of the respective environmental sensor, quickly to an acceptable level. This is particularly important in surroundings where the external temperature or internal operating conditions can result in overheating.

Parallel thereto, a heating module is often used, which is designed to raise the temperature of the environmental sensor from a low level, which is below the minimum working temperature, to a suitable level. This is required in particular in cold climate zones, where adequate functionality of the environmental sensors would not be possible without prior heating.

Both modules have to be connected efficiently and in a heat-conducting manner to the environmental sensor or the sensor module in order to enable rapid and uniform temperature adaptation. The challenge is in particular in installation space technology to provide separate attachment surfaces for each module in order to ensure optimum thermal coupling. This can be problematic, in particular if the available installation space for the attachment surfaces is limited.

### SUMMARY

It is an object of the invention to provide a sensor module having an improved climate control device.

The object is achieved by a sensor module having the features of claim 1.

Advantageous embodiments of the invention are the subject matter of the dependent claims. All combinations of at least two features disclosed in the description, the claims, and/or the figures fall within the scope of the invention. It is understood in this case in particular that colloquial forms and/or an analogous replacement of respective terms in the scope of typical linguistic practice, in particular the use of synonyms supported by the generally recognized language literature, are comprised by the content of the present disclosure, without being explicitly mentioned in their respective formulation.

In one preferred aspect, a sensor module for a motor vehicle is proposed, comprising: a see-through area, an environmental sensor, which can detect the vehicle surroundings through the see-through area, and a climate control device for climate control of the environmental sensor, wherein the climate control device comprises a cooling device having a contact element for in particular thermal contacting and cooling of the environmental sensor and a heating device having at least one heating element, wherein the at least one heating element is arranged at the contact element or is integrated in the contact element.

The contact element is preferably in thermal contact with only a part of the environmental sensor, in particular with only a part of a sensor housing. In contrast to the prior art, two separate devices for cooling and heating can be dispensed with by way of the present climate control device. The climate control device can therefore also be installed in only one single installation step in the present case.

The climate control device can preferably be provided as a preassembled modular unit, in which the cooling device and the heating device are already preassembled. The climate control device can also be provided as a part of a preassembled modular unit, by which the entire thermal management function of the sensor module is provided, possibly also convective cooling and/or forced cooling.

In contrast to a separate attachment of a cooling device and a heating device to the environmental sensor, a combined cooling and heating function can be provided by the present climate control device. In contrast, if the cooling device and the heating device were attached jointly, but as separate units to the environmental sensor, there would be the risk that a part of the heat introduced would be dissipated immediately via the cooling device. Furthermore, the components of the cooling device would also have to be heated as thermal masses, which would increase the thermal inertia of the sensor module. This in turn would result in a comparatively worse efficiency. These disadvantages can be prevented by the present climate control device.

Furthermore, in the present climate control device, a heat conduction between temperature-critical internal sensor components is equally effective both for the cooling device and for the heating device. Due to the combination of both devices, there is also a higher thermal resistance for the heating device in comparison to an attachment of the heating device to an attachment surface of the sensor housing, which is spaced apart from the attachment surface of the cooling device.

The present sensor module convinces due to a lower installation effort, since fewer installation steps are necessary.

In a further aspect, it is proposed that the environmental sensor comprise a base plate or an attachment surface, wherein the contact element is arranged on the base plate or the attachment surface and thermally contacts the base plate or the attachment surface.

The base plate can be used as a thermal attachment surface for the combined cooling and heating device. The combination of the cooling and heating device as a single component makes only a single attachment surface necessary on the environmental sensor. Installation space can be saved in this way. The base plate can preferably be a part of the sensor housing or in other embodiments can also be provided directly at the environmental sensor.

In a further aspect, it is proposed that the climate control device thermally contacts the environmental sensor only via the base plate or the attachment surface in order to cool and/or heat the environmental sensor depending on the operating conditions of the environmental sensor.

The contact element can be coupled, for example, with the base plate of the environmental sensor for the thermal attachment. The thermal path of the heat conduction to the temperature-critical internal components of the environmental sensor is preferably least starting from the base plate. The base plate preferably has the lowest thermal resistance. Effective temperature control of the components of the environmental sensor is possible in this way. This attachment point for the climate control device was typically only occupied by a cooling device in known sensor modules and was therefore not available for a heating device as a thermal attachment. The thermal attachment of the heating device thus took place at another point of the environmental sensor, which resulted in an installation space problem and lengthened the path of the heat conduction to temperature-critical internal components in the heating case and/or was connected to increased thermal resistance and therefore resulted in worse efficiency of the heating device. These disadvantages are avoided in the present case. The base plate can preferably be formed from metal or a highly thermally-conductive material or material mixture.

In a further aspect, it is proposed that the heating element is adhesively bonded or clamped or screwed together with the contact element.

A permanent attachment and a permanently good thermal contact between the heating element and the contact element can thus be ensured.

In a further aspect, it is proposed that the contact element comprises a thermal conduction plate or a thermal conduction surface, by which the environmental sensor can be thermally contacted.

For example, the contact element can be a metal plate or a plate made of a thermally conductive material, which is flatly connected directly to the base plate or another attachment surface. To increase the thermal conductivity, a thermal conduction paste can also be introduced or applied between the contact element and the base plate.

In a further aspect, it is proposed that the cooling device comprise at least one thermal conduction pipe or a heat pipe and a heat exchanger.

Due to the use of thermal conduction pipes (heat pipes), a natural insulation is created between the contact element and the heat exchanger at temperatures below 5° C. by way of the component property thereof, since the function of the thermal conductivity of the heat pipes is not provided at low temperatures. The contact element in the heating case therefore offers the advantage, in particular at low temperatures, of heat distribution onto the entire base plate of the environmental sensor. The otherwise existing negative passive cooling function of the cooling device or its components is prevented by the insulating function of the heat pipes. Vice versa, in the cooling case, the heating element, which is applied to the contact element or integrated therein, has no negative influence on the cooling function.

In a further aspect, it is proposed that the at least one heat conduction pipe is in thermal contact at least in some sections with the contact element, wherein the heat exchanger is arranged spaced apart from the contact element.

A natural insulation can thus be provided between the heat exchanger and the contact element, in particular by the material property of the heat conduction pipes at low temperatures (<5° C.).

In a further aspect, it is proposed that the heating element comprises a heating coil and preferably an electrical contact, wherein the heating coil is at least partially embedded in the contact element.

The heating element can be provided, for example, as a type of heating mat, into which wires are introduced, which can heat up due to an electric current flow and therefore have a heating effect.

In a further aspect, it is proposed that the heating element has an electrical contact, by which the heating element can be supplied with electrical energy. The electrical contact is preferably in electrical contact with the heating coil in order to preferably supply it with energy.

In the present case, a vehicle roof of a motor vehicle comprising at least one sensor module according to an arbitrary embodiment is also claimed.

One preferred embodiment of the vehicle roof is designed as a roof sensor module. Such a roof sensor module forms a modular unit in an integrated manner, which accommodates components required for autonomous or semiautonomous driving of the relevant vehicle. The roof sensor module, in which a plurality of functional elements can thus be integrated, therefore represents a compact modular unit, which is connected on the part of a vehicle producer to a vehicle body or a vehicle shell, which comprises roof spars, such as roof lateral spars and/or roof longitudinal spars. The vehicle roof designed as a roof sensor module thus represents a roof sensor module (RSM), which enables autonomous or semiautonomous driving of the relevant vehicle.

A motor vehicle which is equipped with such a vehicle roof and is designed as an autonomously driving vehicle, drives in the autonomous driving mode independently at least without significant interventions of a driver. In a semiautonomous driving mode, the vehicle roof according to the invention forms a part of a driver assistance system, for example.

The vehicle roof can be provided with a transparent fixed roof section and/or a roof opening system for a roof opening.

In particular, the vehicle roof at least partially forms a roof of a passenger vehicle. However, it can also be a roof of a utility vehicle, which is designed, for example, as a delivery vehicle, as a bus, as an autonomously driving small bus, such as a so-called people mover, or also as a truck tractor unit.

In the present case, a motor vehicle which comprises a sensor module and/or a vehicle roof of the above-described type is also claimed. The vehicle roof preferably forms a roof sensor module (RSM), which is arrangeable as a preassembled modular unit on a vehicle body of the motor vehicle. In other words, in particular a vehicle shell of the motor vehicle can thus be provided with a prefinished or preassembled roof sensor module, which is designed as a roof sensor module.

It is obvious that the abovementioned embodiments and exemplary embodiments and those still to be explained hereinafter can be formed not only individually but also in any combination with one another without departing from the scope of the present invention. It is also obvious that the abovementioned embodiments and exemplary embodiments and those still to be explained hereinafter relate in an equivalent or at least similar manner to all embodiments of the invention, without being separately mentioned in each case.

### BRIEF DESCRIPTION OF DRAWINGS

Embodiments of the invention are schematically shown in the drawings and will be explained by way of example hereinafter.

FIG. 1 shows a schematic representation of a vehicle roof having a sensor module.

FIG. 2 shows a schematic view of an exemplary embodiment of a climate control device.

FIG. 3 shows a schematic view of an exemplary embodiment of a climate control device.

### DETAILED DESCRIPTION

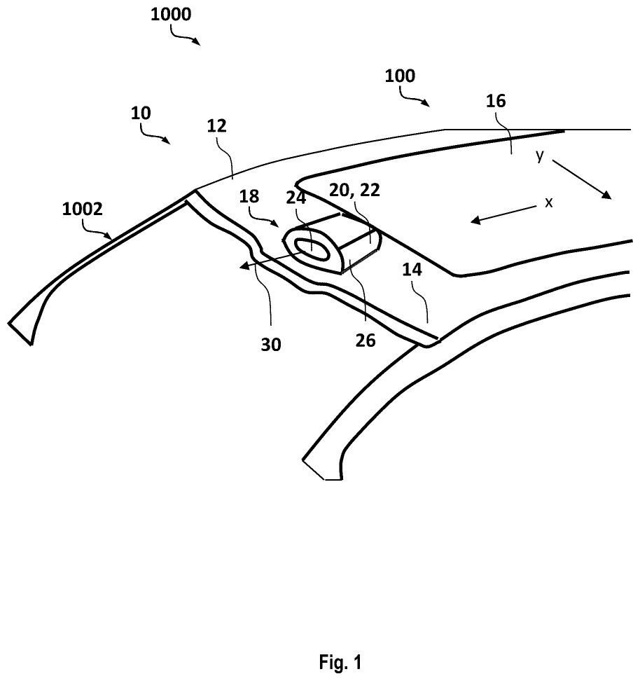

FIG. 1 schematically shows a motor vehicle 1000, which comprises a vehicle body 1002. Furthermore, the motor vehicle 1000 comprises a roof sensor module 10, which is arranged as a modular unit on the vehicle body 1002 and forms a vehicle roof 100 of the motor vehicle 1000 at least in some areas. The roof sensor module 10 can be provided as a preassembled modular unit.

In alternative embodiments, the vehicle roof 100 can also be a vehicle roof which is not designed as a roof sensor module. All embodiments therefore also relate to such a vehicle roof 100.

The roof sensor module 10 comprises a planar component 12, which forms a roof skin 14 of the vehicle roof 100 at least in some areas. The roof sensor module 10 comprises a fixed roof element 16 according to FIG. 1, which forms an at least partially transparent area of the vehicle roof 100. In other or additional embodiments, the roof sensor module 10 can comprise a roof opening system, which comprises a cover element, which is movable to alternately open or close a roof opening.

The roof sensor module 10 or the vehicle roof 100 comprises a sensor module 18. The sensor module 18 can comprise a cover 20. Furthermore, the sensor module 18 comprises at least one environmental sensor 22 for detecting the vehicle surroundings. The environmental sensor 22 is configured to detect the vehicle surroundings via a see-through area 24. The see-through area 24 is arranged in the present case on the cover 20. The environmental sensor 22 can be a lidar sensor and/or a camera and/or a radar sensor and/or an ultrasonic sensor and/or a multi-camera sensor. Other sensors are also conceivable.

The environmental sensor 22 can be arranged in a sensor housing 26. The environmental sensor 22 can be arranged below the cover 20 or can be covered by the cover 20. The see-through area 24 can be provided as a window in an opening (not shown in more detail) of the cover 20. The see-through area 24 can be provided integrally in the cover 20 or can be arranged separately therein. The see-through area 24 can also be provided in the sensor housing 26.

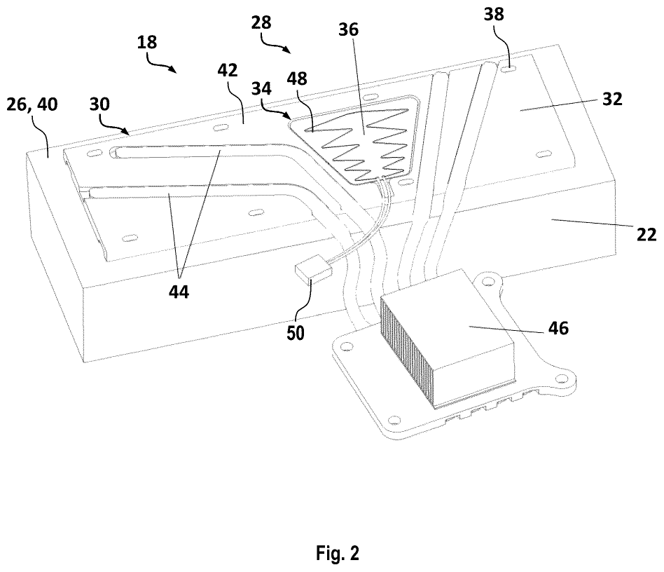

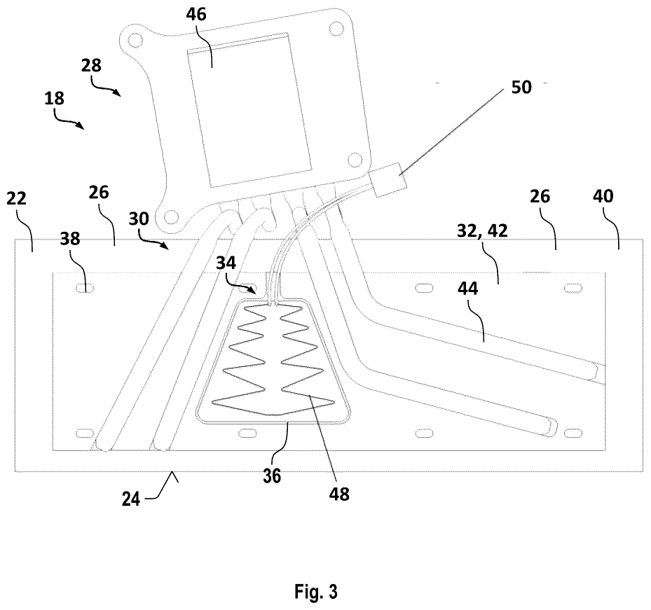

As can be seen from FIGS. 2 and 3, the sensor module 18 comprises a climate control device 28 for climate control of the environmental sensor 22.

The climate control device 28 comprises a cooling device 30 having a contact element 32 for in particular thermally contacting and, inter alia, cooling of the environmental sensor 22. The climate control device 28 furthermore comprises a heating device 34 having at least one heating element 36. The at least one heating element 36 is arranged on the contact element 32 or integrated in the contact element 32. In the present case, the heating element 36 is clamped with the contact element 32 via clamps 38. The heating element 36 can also be adhesively bonded and/or screwed together with the contact element 32.

The environmental sensor 22 comprises a base plate 40 or an attachment surface. The contact element 32 is arranged on the base plate 40 or the attachment surface and thermally contacts the base plate 40 or the attachment surface. In the present case, the base plate 40 is a part of the sensor housing 26. In other embodiments, the base plate 40 can also be a separate component, which is attached to the environmental sensor 22. In the present case, the climate control device 28 thermally contacts the environmental sensor 22 only, i.e. exclusively, via the base plate 40 or the attachment surface, in order to cool the environmental sensor 22 by using the cooling device 30 and/or heat it by using the heating device 34 depending on the operating conditions of the environmental sensor 22.

The contact element 32 comprises a thermal conduction plate 42 or a thermal conduction surface. The contact element 32 can be produced from a flexible, for example, mat-shaped material or from a metal. The contact element 32 thermally contacts the environmental sensor 22 via the thermal conduction plate 42 in order to ensure a heat transfer.

The cooling device 30 comprises at least one heat conduction pipe 44 and a heat exchanger 46. The at least one heat conduction pipe 44 is in thermal contact at least in some sections with the contact element 32, for example, adhesively bonded or welded thereto. The heat exchanger 46 is arranged spaced apart from the contact element 32 and preferably forms a heatsink. The heating element 36 comprises a heating coil 48 and an electrical contact 50, in particular one or more cables and a plug connection. The heating coil 48 is at least partially embedded in the contact element 32 in the present case.

### LIST OF REFERENCE SIGNS

10 roof sensor module
12 planar component
14 roof skin
16 fixed roof element
18 sensor module
20 cover
22 environmental sensor
24 see-through area
26 sensor housing
28 climate control device
30 cooling device
32 contact element
34 heating device
36 heating element
38 clamps
40 base plate
42 thermal conduction plate
44 heat conduction pipe
46 heat exchanger
48 heating coil
50 contact
100 vehicle roof
1000 motor vehicle
1002 vehicle body
x vehicle longitudinal direction
y vehicle width direction

1. A sensor module for a motor vehicle, comprising:
a see-through area,
an environmental sensor, which can detect the vehicle environment through the see-through area, and
a climate control device for the climate control of the environmental sensor,
wherein the climate control device comprises a cooling device having a contact element for thermally contacting and cooling the environmental sensor and a heating device having at least one heating element,
wherein the at least one heating element is arranged at the contact element or is integrated in the contact element.

2. The sensor module according to claim 1, wherein the environmental sensor comprises a base plate or an attachment surface, wherein the contact element is arranged at the base plate or the attachment surface and thermally contacts the base plate or the attachment surface.

3. The sensor module according to claim 2, wherein the climate control device thermally contacts the environmental sensor only via the base plate or the attachment surface to cool and/or heat the environmental sensor depending on the operating conditions of the environmental sensor.

4. The sensor module according to claim 1, wherein the heating element is adhesively bonded or clamped or screwed together with the contact element.

5. The sensor module according to claim 1, wherein the contact element comprises a thermal conduction plate or a thermal conduction surface, by which the environmental sensor can be thermally contacted.

6. The sensor module according to claim 1, wherein the cooling device comprises at least one heat conduction pipe and a heat exchanger.

7. The sensor module according to claim 1, wherein the at least one heat conduction pipe is in thermal contact with the contact element at least in some sections and wherein the heat exchanger is arranged spaced apart from the contact element.

8. The sensor module according to claim 1, wherein the heating element comprises a heating coil and/or an electrical contact, wherein the heating coil is at least partially embedded in the contact element.

9. A vehicle roof of a motor vehicle, comprising at least one sensor module according to claim 1.

10. A motor vehicle, comprising the sensor module according to claim 1, wherein the vehicle roof forms a roof sensor module, which is arrangeable as a preassembled modular unit on a vehicle body of the motor vehicle.

11. A motor vehicle, comprising the vehicle roof of claim 9, wherein the vehicle roof forms a roof sensor module, which is arrangeable as a preassembled modular unit on a vehicle body of the motor vehicle.

12. A motor vehicle having a vehicle roof, the vehicle roof comprising at least one sensor module according to claim 1, wherein the vehicle roof forms a roof sensor module, which is arrangeable as a preassembled modular unit on a vehicle body of the motor vehicle.
